(19) United States
(12) Patent Application Publication
(10) Pub. No.: US 2026/0140131 A1
(43) Pub. Date: May 21, 2026

(54) AUTOMATED MEDICAL SAMPLING AND TRANSPORTATION LINE FOR REDUCING TESTING ERROR RATE AND METHOD THEREFOR

(71) Applicants: Wenzhou University of Technology, Wenzhou (CN); Wenzhou People’s Hospital, Wenzhou (CN)

(72) Inventors: Yuanyuan Wang, Wenzhou (CN); Mengjie Xu, Wenzhou (CN); Haishao Chen, Wenzhou (CN); Kai Xu, Wenzhou (CN); Xiaoshu Chen, Wenzhou (CN)

(21) Appl. No.: 19/246,512

(22) Filed: Jun. 23, 2025

(30) Foreign Application Priority Data
Nov. 15, 2024 (CN) 202411631877.0

(51) Int. Cl. G01N 35/04; G01N 35/00

(52) U.S. Cl. CPC G01N 35/04; G01N 35/00732; G01N 2035/00752; G01N 2035/0439

(57) ABSTRACT

The present invention provides an automated medical sampling and transportation line for reducing testing error rate and a method therefor, which solve the defects that existing manual collection greatly increases the labor intensity of medical staff and easily confuses specimen labels with specimen tubes. The automated medical sampling and transportation line includes a base, where a first mounting plate is fixed to a top of the base, two rotating rollers are rotatably connected to one side of the first mounting plate, the two rotating rollers are in transmission connection by a conveying belt, a plurality of placing sleeves are fixed to an outer wall of the conveying belt, and test tubes are placed in the placing sleeves. According to the present invention, the specimen may be unified tested later without manual operation, the collection efficiency is improved, and the working intensity is reduced.

### CROSS-REFERENCE TO RELATED APPLICATIONS

This application claims priority to Chinese Patent Application No. 202411631877.0, filed on Nov. 15, 2024, which is hereby incorporated by reference in its entirety.

### TECHNICAL FIELD

The present invention relates to the technical field of medical detection equipment, and in particular, to an automated medical sampling and transportation line for reducing testing error rate and a method therefor.

### BACKGROUND

Pathogen nucleic acid testing is a testing method for determining whether human secretion specimens are infected by foreign invading viruses by searching for nucleic acid of the viruses in the human secretion specimens. Respiratory pathogen nucleic acid testing uses respiratory secretions as specimens to test and determine whether the respiratory tract is infected by foreign invading viruses. The pathogen nucleic acid testing may also be used to diagnose diseases in other parts of the body in addition to respiratory diseases.

In the prior art, there are still the following deficiencies when specimens are collected:
1. When collecting specimens, medical staff need to insert a pharyngeal swab into the respiratory tract to collect respiratory secretion specimens, and then put the pharyngeal swab into a specimen tube. When there are a large number of specimens to be collected, the labor intensity of medical staff is greatly increased.
2. When a large number of specimens are collected, it is easy to make medical staff tired, and cause the medical staff to confuse specimen labels with specimen tubes, affecting the accuracy of subsequent tests.

To solve the above problems, the present invention proposes an automated medical sampling and transportation line for reducing testing error rate and a method therefor.

### SUMMARY

To solve the defects that existing manual collection greatly increases the labor intensity of medical staff and that manual collection easily confuses specimen labels with specimen tubes, the present invention provides an automated medical sampling and transportation line for reducing testing error rate and a method therefor.

To achieve the above objective, the present invention adopts the following technical solutions.

An automated medical sampling and transportation line for reducing testing error rate includes a base, wherein a first mounting plate is fixed to a top of the base, two rotating rollers are rotatably connected to one side of the first mounting plate, the two rotating rollers are in transmission connection by a conveying belt, a plurality of placing sleeves are fixed to an outer wall of the conveying belt, and test tubes are placed in the placing sleeves;
a rotating column above the first mounting plate, wherein a pharyngeal swab is mounted at one end of the rotating column and configured to collect an oral specimen from a patient, a support plate is fixed to a top of the base, a sampling hole is formed in the support plate, and the pharyngeal swab penetrates through the sampling hole and is configured to collect the specimen;
a placing rack arranged at one side of the first mounting plate, wherein a connecting plate is fixed at one end of the first mounting plate, a U-shaped bracket is fixed at one side of the connecting plate, a rotating rod rotatably penetrates through the U-shaped bracket, the placing rack is placed at a top end of the rotating rod, and a plurality of inserting holes configured to place the test tubes are provided in the placing rack;
a vacuum cup arranged at one side of the first mounting plate and configured to place a test tube with the specimen in the placing rack;
an identification structure arranged at one side of the support plate and configured to associate information of a patient with a corresponding test tube;
a collection structure arranged at a top of the first mounting plate and configured to drive the pharyngeal swab to collect a specimen;
a transportation structure arranged at a top of the first mounting plate and configured to place a test tube with the collected specimen on the placing rack; and
a rotating structure arranged in the U-shaped bracket and configured to drive the placing rack to rotate, so that the test tube is placed in the placing rack.

In a possible design, the identification structure includes a camera and a chin rest fixed at one side of the support plate, the camera is configured to collect facial data of a patient, the chin rest is configured to support the chin of the patient, an identity card reader is fixed at the top of the base and configured to read identity card information of the patient, an inkjet printer is fixed at the top of the first mounting plate, the inkjet printer is configured to spray a QR code on the outer wall of the test tube, a control terminal is provided in the base, and the camera, the identity card reader and the inkjet printer are all electrically connected to the control terminal. The identity card reader reads the identity information of the patient, the camera takes a picture of the appearance of the patient, and then the patient places the chin on the chin rest and aligns the mouth with the sampling hole to facilitate later specimen collection. The camera and the identity card reader transmit the information to the Internet by the control terminal. The Internet uses the inkjet printer to spray patient information in the form of a QR code onto the outer wall of a test tube. This allows the collected specimen to be placed inside the test tube, thereby preventing confusion between the specimen and patient information.

In a possible design, the collection structure includes an L-shaped bracket fixed at one side of the first mounting plate far away from the conveying belt, one side of the L-shaped bracket close to the conveying belt is rotatably connected to one end of the rotating column, a rotating shaft is rotatably connected in the rotating column, a support rod is fixedly sleeved on an outer wall of the rotating shaft, a first electric push rod is fixedly embedded at one end of the support rod, a second mounting plate is fixed at an output end of the first electric push rod, a rectangular groove is formed at one side of the second mounting plate far away from the support rod, a wiping arm is slidably connected in the rectangular groove, a guide rod slidably penetrating through the wiping arm is fixed in the rectangular groove, a first spring fixedly connected to an inner wall of a bottom of the rectangular groove is sleeved on an outer wall of the guide rod, a top of the first spring is fixedly connected to a bottom of the wiping arm, the first spring cooperates with the guide rod to move the wiping arm upward and away from a center, and a mechanical claw is fixed to an outer wall of the wiping arm and configured to grab the pharyngeal swab. An output shaft of the first electric push rod pushes the second mounting plate and the wiping arm through the sampling hole and inserts the wiping arm into the oral cavity of the patient, and then the motor drives the rotating column and the wiping arm to rotate. Since the wiping arm moves upward under the action of the first spring, the second mounting plate drives the wiping arm and the pharyngeal swab to rotate eccentrically, and after rotating one circle, the wiping arm and the pharyngeal swab rotate in an opposite direction to reset, and the pharyngeal swab wipes the oral cavity of the patient to complete the specimen collection. Afterwards, the first electric push rod drives the second mounting plate to retract and reset, the motor drives the support rod to rotate 90° through the rotating shaft to arrange vertically downward, the mechanical claw releases the clamping of the pharyngeal swab, and the pharyngeal swab falls into the test tube.

In a possible design, the transportation structure rotates a driving shaft at the top of the first mounting plate through the base, the driving shaft is in transmission connection with the rotating column through a synchronous wheel and a synchronous belt, the rotating column rotates one circle to drive the driving shaft to rotate half a circle, a rotating plate is fixed at one end of the driving shaft, a clearance groove is provided at one side of the rotating plate, a sliding block is slidably connected in the clearance groove, a second electric push rod is fixed on an inner wall of one side of the clearance groove, an output shaft of the second electric push rod is fixedly connected to the sliding block for adjusting positions of the sliding block and the vacuum cup, so that the vacuum cup places the test tube in a corresponding inserting hole on the placing rack, a vertical rod is rotatably connected to one side of the sliding block by a fixed column, a bottom end of the vertical rod is fixedly connected to the vacuum cup, and the gravity of the vertical rod and the vacuum cup keeps the vertical rod in a vertical state. The conveying belt conveys the test tube to a bottom of the vertical rod, and the vacuum cup abuts against the top of the cap, and the test tube is adsorbed by the vacuum cup. When the rotating column rotates again to complete the next specimen collection, the rotating column rotates one circle to drive the driving shaft and the rotating plate to rotate half a circle through the synchronous wheel and the synchronous belt, and the rotating plate drives the test tube to move toward the placing rack through the sliding block. Due to the action of the vertical rod and the test tube, when the rotating plate rotates, the vertical rod and the test tube always keep in a vertical state. The test tube may be placed in the placing rack when the rotating plate rotates half a circle, and the rotating plate resets when the rotating column resets.

In a possible design, the rotating structure includes a first one-way bearing sleeved on an outer wall of the rotating rod, the first one-way bearing is positioned in the U-shaped bracket, a first gear is fixed on an outer ring of the first one-way bearing, an inner ring of the first one-way bearing is fixed on the outer wall of the rotating rod, the first gear cooperates with the first one-way bearing to drive the rotating rod to rotate in one direction, a supporting plate is slidably connected to an inner wall of one side of the U-shaped bracket, a rack meshed with the first gear is fixed at one side of the supporting plate, a positioning block is fixed on the inner wall of one side of the U-shaped bracket, an insertion rod slidably penetrates into the positioning block, one end of the insertion rod is fixedly connected to the supporting plate, a second spring is fixed between the supporting plate and the positioning block, the second spring is sleeved on an outer wall of the insertion rod, the second spring is configured to drive the rack and the first gear to reset, a fixing ring is fixedly sleeved on an outer wall of the placing sleeve, hemispherical protrusions are fixed on two sides of a top of the fixing ring, and the hemispherical protrusions cooperate with the rack to drive the rack to move to one side. The conveying belt drives the placing sleeve to move. When the placing sleeve runs to one side of the rotating roller, the hemispherical protrusion on the outer wall of the placing sleeve pushes the rack to move to the right, the rack cooperates with the first gear to drive the first one-way bearing to rotate, the first one-way bearing and the rotating rod are in a locked state, the rotating rod and the placing rack are driven to rotate, which adjusts the angle of the placing rack, so that the test tubes may be placed on the placing rack later. After the hemispherical protrusion is disengaged from the rack, the rack resets under the action of the second spring, and the rack drives the first gear to rotate in the opposite direction, and the first one-way bearing and the rotating rod are in an active state.

In a possible design, a cap is rotatably connected to an outer wall of the test tube, a circular clamping groove is formed in an inner wall of the test tube close to an opening, a rubber ring is fixed to one side of the cap, the rubber ring cooperates with the circular clamping groove for increasing the stability of sealing between the cap and the test tube, and a rotating wheel is rotatably connected to one side of the first mounting plate and configured to push the cap to seal the test tube.

In a possible design, a bottom plate is fixed on the top end of the rotating rod, a plurality of pins are provided on a top of the bottom plate, and a plurality of pin holes matched with the pins are provided on a bottom of the placing rack for positioning the placing rack and the bottom plate. The cooperation between the pins and the pin holes may not only enable the bottom plate to drive the placing rack to rotate, but also limit the placement angle of the placing rack, so that the insertion hole on the placing rack cooperates with the vertical rod to receive the test tube later.

In a possible design, a fixed cylinder is fixed at one side of the support plate close to the first mounting plate, a circular rod is slidably connected in the fixed cylinder, a circular ring is fixed at one end of the circular rod, a third electric push rod is fixed at one side of the support plate, an output shaft of the third electric push rod is fixedly connected to the circular ring, the third electric push rod is configured to push the circular ring to move, a circular placement box is rotatably connected in the circular ring, a plurality of pharyngeal swabs are placed in the circular placement box, a bottom end of a wooden stick of each pharyngeal swab extends below the circular placement box, a second one-way bearing is sleeved on an outer wall of the circular placement box, an inner ring of the second one-way bearing is fixedly connected to an outer wall of the circular placement box, a straight-tooth ring is fixedly sleeved on an outer ring of the second one-way bearing, a driving rod is rotatably connected to one side of the circular ring through the base, a second gear is fixed to a top end of the driving rod, the second gear is meshed with the straight-tooth ring, the straight-tooth ring cooperates with the second one-way bearing to drive the circular placement box to rotate in one direction, a bevel gear is fixed to a bottom end of the driving rod, a collar is sleeved on an outer wall of the rotating column, the collar is rotatably connected to the driving rod through the base, one side of the collar is rotatably connected to a bevel gear ring meshed with the bevel gear, and the bevel gear ring is slidably sleeved on the outer wall of the rotating column. The motor drives the rotating shaft and the support rod to rotate 90°, the support rod drives the mechanical claw to rotate upward, the mechanical claw is positioned below the circular placement box, and the first electric push rod cooperates with the mechanical claw to grab the pharyngeal swab in the circular placement box. In addition, when the rotating column rotates, the circular placement box is driven to rotate through the cooperation of the bevel gear ring, the bevel gear, the straight-tooth ring, and the second gear, and the position of the circular placement box is adjusted to facilitate the mechanical claw to grab the pharyngeal swab later. When the rotating column rotates in the opposite direction, the second one-way bearing between the straight-tooth ring and the circular placement box cannot make the straight-tooth ring drive the circular placement box to rotate. In addition, the output shaft of the third electric push rod can push the circular placement box to move, so that the mechanical claw may change the position to grab the pharyngeal swab.

In a possible design, a plurality of sliding grooves are provided on the outer wall of the rotating column, a plurality of sliding blocks are fixed to an inner wall of the bevel gear ring, and the sliding blocks are slidably arranged in the sliding grooves. When the rotating column rotates, the bevel gear ring is driven to rotate through the sliding grooves and the sliding blocks, and the driving rod drives the bevel gear ring to slide along an axial direction of the rotating column through the collar, so that the rotating column may always drive the circular placement box to rotate.

According to the present invention, a method for using the automated medical sampling and transportation line for reducing testing error rate includes the following steps:
S1. the test tube is inserted into the placing sleeve, and the cap is opened facing to a left side; identity information and an appearance of a patient are recorded through the identity card reader and the camera; the chin of the patient is placed on the chin rest, and the mouth of the patient is aligned with the sampling hole for sampling; the information is automatically transmitted to the Internet, and the inkjet printer generates a QR code on the outer wall of the test tube to ensure that specimen information is accurate;
S2. the first electric push rod pushes the wiping arm to enter the oral cavity of the patient, and a motor drives the wiping arm to eccentrically rotate so as to complete specimen collection by the pharyngeal swab; after collection, the first electric push rod resets, the motor adjusts a direction of the support rod, and the mechanical claw releases the pharyngeal swab into the test tube;
S3. the conveying belt drives the test tube to a capping position, and the rotating wheel automatically caps; the vacuum cup absorbs the test tube, rotates to a position above the placing rack along with the rotating plate and accurately places the test tube;
S4. when the placing sleeve moves, the hemispherical protrusion triggers the rack to drive the placing rack to rotate to a proper angle; after the rack resets, the first one-way bearing is unlocked, and the placing rack keeps a current angle;
S5. the mechanical claw is driven by the motor to cooperate with the first electric push rod to grab a new pharyngeal swab from the circular placement box; the rotating column adjusts a position of the circular placement box through gear transmission to facilitate the mechanical claw to grab; and the third electric push rod pushes the circular placement box to increase grabbing flexibility.

### Beneficial Effects

According to the present invention, a camera is fixed at one side of the support plate, an identity card reader is fixed on the top of the base, an inkjet printer is fixed on the top of the first mounting plate, a control terminal is arranged in the base, and the camera, the identity card reader and the inkjet printer are all electrically connected to the control terminal; the identity card reader reads the identity information of the patient, the camera takes a picture of the appearance of the patient, the camera and the identity card reader transmit the information to the Internet by the control terminal, and the Internet uses the inkjet printer to spray patient information in the form of a QR code onto the outer wall of a test tube. This allows the collected specimen to be placed inside the test tube, thereby preventing confusion between the specimen and patient information.

According to the present invention, a support rod is rotated in a rotating column by a rotating shaft, a second mounting plate is fixed at one end of the support rod through a first electric push rod, a wiping arm is slidably connected in the second mounting plate, and a mechanical claw is fixed to an outer wall of the wiping arm and configured to grab a pharyngeal swab; an output shaft of the first electric push rod pushes the second mounting plate and the wiping arm to penetrate through the sampling hole and inserts the wiping arm into the oral cavity of the patient, and the wiping arm moves upwards under the action of the first spring, so that the second mounting plate drives the wiping arm and the pharyngeal swab to eccentrically rotate, which may automatically collect specimens. After collection, the specimens may be automatically packaged without manual operation, which not only improves the collection efficiency but also reduces work intensity.

According to the present invention, a rotating plate is fixed at one end of a driving shaft, a sliding block is slidably connected to the rotating plate by a clearance groove, a vertical rod is rotatably connected to one side of the sliding block by a fixed column, a bottom end of the vertical rod is fixedly connected to the vacuum cup; the rotating column rotates one circle to drive the driving shaft and the rotating plate to rotate half a circle through the synchronous wheel and the synchronous belt, the rotating plate drives the test tube to move toward the placing rack through the sliding block, when the rotating plate rotates half a circle, the test tube may be placed in the placing rack, and the test tube is automatically placed, which is convenient for the unified transportation of a plurality of test tubes into a collection box later, and is convenient for the unified test of the specimens later.

According to the present invention, the collection and the packaging of the specimen may be automatically completed with the cooperation of the rotating column, the first electric push rod and the mechanical claw, and the packaged test tube may be automatically collected in the placing rack with the cooperation of the rotating column and the driving shaft, so that the specimen may be unified tested later without manual operation, the collection efficiency is improved, and the working intensity is reduced. In addition, during the collection process, the information of the patient may be automatically converted into a QR code and printed on the test tube to avoid confusion between the specimen and the information of the patient.

### BRIEF DESCRIPTION OF DRAWINGS

FIG. 1 is a schematic diagram of a three-dimensional structure of an automated medical sampling and transportation line for reducing testing error rate according to Embodiment 1 of the present invention;

FIG. 2 is a schematic diagram of a three-dimensional structure of a base, an L-shaped bracket, an inkjet printer and a rotating wheel of an automated medical sampling and transportation line for reducing testing error rate according to Embodiment 1 of the present invention;

FIG. 3 is a schematic diagram of a three-dimensional structure of a rotating roller and a conveying belt of an automated medical sampling and transportation line for reducing testing error rate according to Embodiment 1 of the present invention;

FIG. 4 is a schematic diagram of a three-dimensional structure of a placing sleeve and a test tube of an automated medical sampling and transportation line for reducing testing error rate according to Embodiment 1 of the present invention;

FIG. 5 is a schematic diagram of a three-dimensional exploded structure of a rotating column, a support rod and a second mounting plate of an automated medical sampling and transportation line for reducing testing error rate according to Embodiment 1 of the present invention;

FIG. 6 is a schematic diagram of a three-dimensional exploded structure of a second mounting plate and a wiping arm of an automated medical sampling and transportation line for reducing testing error rate according to Embodiment 1 of the present invention;

FIG. 7 is a schematic diagram of a three-dimensional exploded structure of a rotating plate and a vertical rod of an automated medical sampling and transportation line for reducing testing error rate according to Embodiment 1 of the present invention;

FIG. 8 is a schematic diagram of a three-dimensional exploded structure of a placing rack, a bottom plate and a U-shaped bracket of an automated medical sampling and transportation line for reducing testing error rate according to Embodiment 1 of the present invention;

FIG. 9 is a schematic diagram of a three-dimensional cross-sectional structure of a U-shaped bracket of an automated medical sampling and transportation line for reducing testing error rate according to Embodiment 1 of the present invention;

FIG. 10 is a schematic diagram of a three-dimensional structure of an automated medical sampling and transportation line for reducing testing error rate according to Embodiment 2 of the present invention;

FIG. 11 is a schematic diagram of a three-dimensional exploded structure of a rotating column, a circular placement box and a third electric push rod of an automated medical sampling and transportation line for reducing testing error rate according to Embodiment 2 of the present invention; and

FIG. 12 is a schematic diagram of a three-dimensional exploded structure of a bevel gear ring and a driving rod of an automated medical sampling and transportation line for reducing testing error rate according to Embodiment 2 of the present invention.

Reference numerals: 1. base; 2. first mounting plate; 3. rotating roller; 4. conveying belt; 5. placing sleeve; 6. test tube; 7. cap; 8. annular clamp groove; 9. rubber ring; 10. fixing ring; 11. hemispherical protrusion; 12. L-shaped bracket; 13. rotating column; 14. rotating shaft; 15. support rod; 16. first electric push rod; 17. second mounting plate; 18. rectangular groove; 19. guide rod; 20. wiping arm; 21. first spring; 22. mechanical claw; 23. pharyngeal swab; 24. support plate; 25. chin rest; 26. sampling hole; 27. camera; 28. identity card reader; 29. inkjet printer; 30. rotating wheel; 31. driving shaft; 32. rotating plate; 33. clearance groove; 34. sliding block; 35. second electric push rod; 36. vertical rod; 37. vacuum cup; 38. connecting plate; 39. U-shaped bracket; 40. rotating rod; 41. bottom plate; 42. pin; 43. placing rack; 44. first one-way bearing; 45. first gear; 46. supporting plate; 47. rack; 48. insertion rod; 49. second spring; 50. positioning block; 51. fixed cylinder; 52. circular rod; 53. circular ring; 54. third electric push rod; 55. circular placement box; 56. straight-tooth ring; 57. driving rod; 58. second gear; 59. collar; 60. bevel gear ring; 61. bevel gear; 62. identification structure; 63. collection structure; 64. transportation structure; 65. rotating structure; 66. second one-way bearing; 67. base; 68. control terminal; 69. synchronous wheel; 70. synchronous belt; 71. fixed column; 72. pin hole; 73. sliding groove; and 74. sliding block.

### DESCRIPTION OF EMBODIMENTS

The following clearly and completely describes the technical solutions in embodiments of the present invention with reference to the accompanying drawings in embodiments of the present invention. It is clear that the described embodiments are merely a part rather than all of embodiments of the present invention.

### Embodiment 1

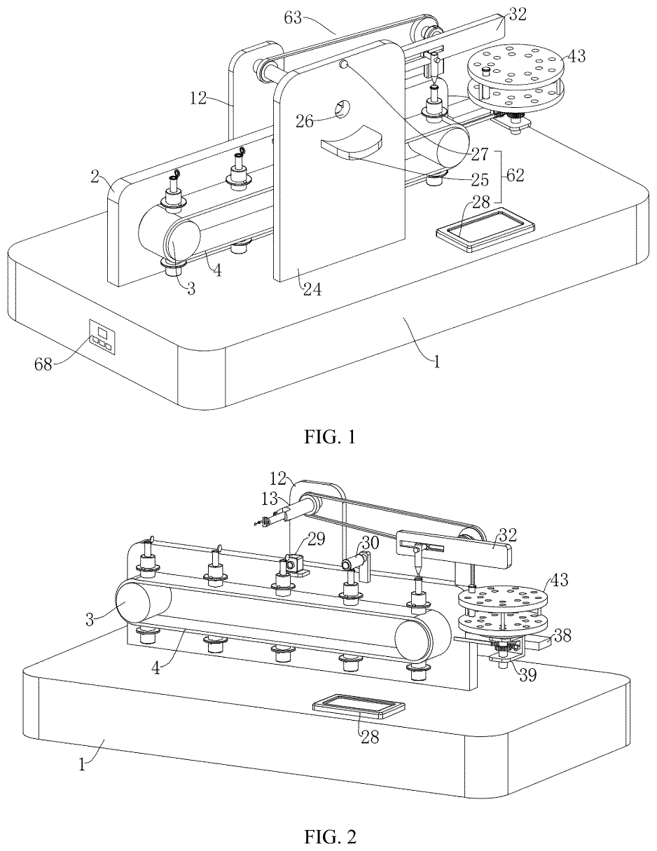

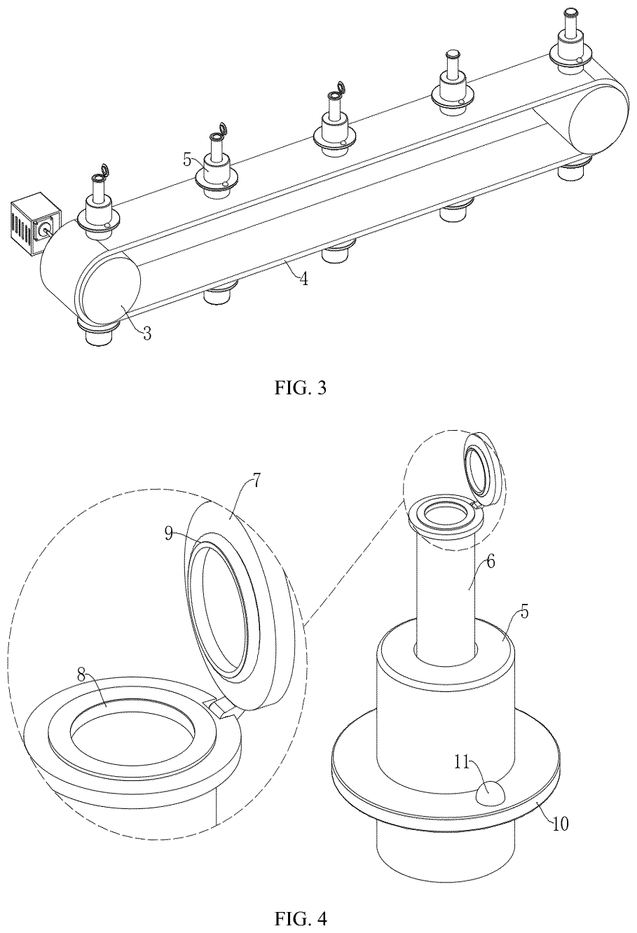

Referring to FIGS. 1-3, a transportation line, applied to the field of medical detection equipment, is mainly composed of a base 1, and a first mounting plate 2 is fixed on a top of the base 1. Two rotating rollers 3 are rotatably connected to one side of the first mounting plate 2 via a bearing seat, and the two rotating rollers 3 are connected by a conveying belt 4. A plurality of placing sleeves 5 are fixed at equal intervals on an outer wall of the conveying belt 4, and each placing sleeve 5 is configured to place a test tube 6 so as to carry the test tube 6 during transportation.

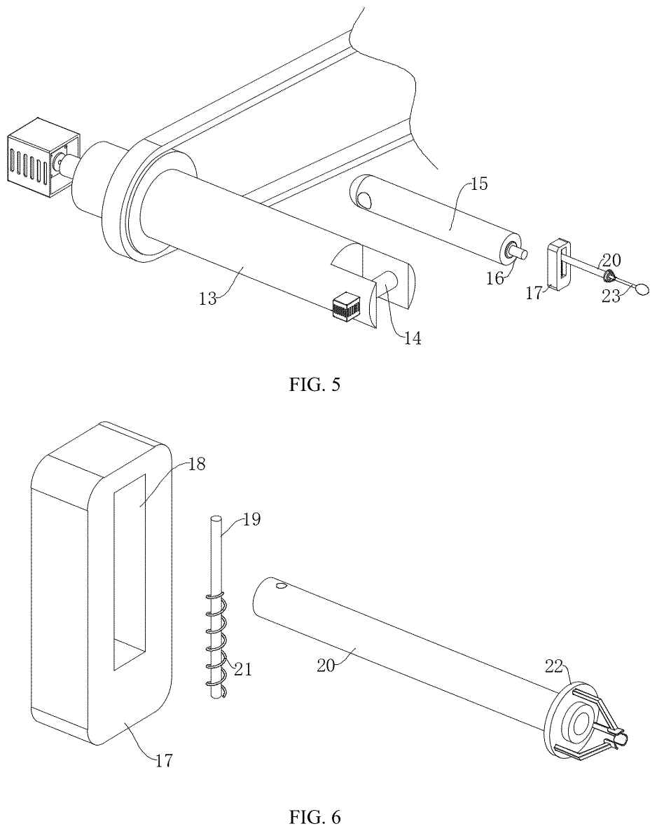

Referring to FIGS. 1, 2 and 5, a rotating column 13 is provided above the first mounting plate 2, and a pharyngeal swab 23 is mounted to one end of the rotating column and configured to collect an oral specimen from a patient. A support plate 24 is fixed on the top of the base 1, a sampling hole 26 is provided in the support plate 24, and a pharyngeal swab 23 penetrates through the sampling hole 26 so as to extend into the oral cavity of the patient from the outside for specimen collection.

Referring to FIGS. 1, 2 and 8, a placing rack 43 is provided at one side of the first mounting plate 2 and configured to store collected test tubes 6. A connecting plate 38 is fixed at one end of the first mounting plate 2, and a U-shaped bracket 39 is fixed at one side of the connecting plate 38. A rotating rod 40 is rotatably penetrated in the U-shaped bracket 39 via a bearing. The placing rack 43 is placed on the top of the rotating rod 40 and rotates through the rotating structure 65. The placing rack 43 is provided with a plurality of insertion holes, into which the test tubes 6 are inserted and fixed.

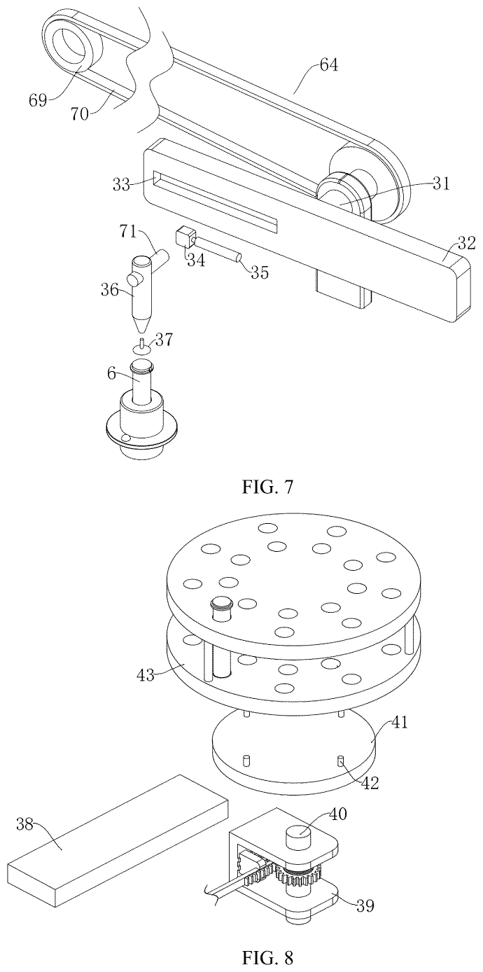

Referring to FIGS. 2 and 7, to remove the test tube 6 from the conveying belt 4 and place the test tube on the placing rack 43, a vacuum cup 37 is provided as an auxiliary tool. The vacuum cup 37 absorbs the test tube 6 and moves the test tube to the top of the placing rack 43, and then releases the test tube 6 to make it fall into the insertion hole.

Referring to FIGS. 1 and 2, the identification structure 62 includes a camera 27 and chin rest 25 mounted at one side of the support plate 24. The camera 27 is configured to collect facial data of a patient, and the chin rest 25 is configured to support the chin of the patient, so that the patient may stably face the sampling hole 26. An identity card reader 28 is also fixed to the top of the base 1 and is configured to read the identity card information of the patient. The information is processed by a control terminal 68, and an inkjet printer 29 sprays a QR code on an outer wall of the test tube 6, thereby associating the patient information with the test tube 6.

Referring to FIGS. 2, 5 and 6, the collection structure 63 mainly includes an L-shaped bracket 12, a rotating column 13, a rotating shaft 14, a support rod 15, a first electric push rod 16, a second mounting plate 17, a rectangular groove 18, a guide rod 19, a first spring 21, a wiping arm 20 and a mechanical claw 22. The L-shaped bracket 12 is fixed at one side of the first mounting plate 2 far away from the conveying belt 4. One end of the rotating column 13 is rotatably connected to the L-shaped bracket 12, and the other end is connected to the support rod 15 via a rotating shaft 14. A first electric push rod 16 is fixed on the support rod 15, and an output end of the first electric push rod is connected to a second mounting plate 17. A rectangular groove 18 is provided on the second mounting plate 17, and a wiping arm 20 is slidably connected to the interior of the rectangular groove. A mechanical claw 22 is fixed on the wiping arm 20 for grabbing a pharyngeal swab 23. When a specimen needs to be collected, the first electric push rod 16 pushes the wiping arm 20 and the pharyngeal swab 23 into the oral cavity of the patient, and the specimen is collected through the rotation of the rotating column 13.

Referring to FIGS. 2, 5 and 7, the transportation structure 64 allows the automatic transport and placement of the test tubes 6 mainly via the conveying belt 4 and the vacuum cups 37. The structure mainly rotates a driving shaft 31 at the top of the first mounting plate 2 through the base 67 to achieve the transmission and placement of the test tube 6. Specifically, the driving shaft 31 is in transmission connection with the rotating column 13 through a synchronous wheel 69 and a synchronous belt 70, which ensures that the driving shaft 31 rotates half a circle when the rotating column 13 rotates one circle. A rotating plate 32 is fixed at one end of the driving shaft 31, a clearance groove 33 is formed in one side of the rotating plate 32, and a sliding block 34 is slidably connected to the clearance groove 33. The second electric push rod 35 is mounted on an inner wall of one side of the clearance groove 33, and an output shaft of the second electric push rod is fixedly connected to the sliding block 34 for adjusting the position of the sliding block 34 and the vacuum cup 37 fixed on the sliding block 34. A vertical rod 36 is rotatably connected to the sliding block 34 through a fixed column 71, and the bottom end of the vertical rod 36 is fixedly connected to a vacuum cup 37. The vertical rod 36 is always kept in a vertical state under the gravity action of the vertical rod 36 and the vacuum cup 37. When the conveying belt 4 conveys the test tube 6 to the position below the vertical rod 36, the vacuum cup 37 abuts against the top of the cap 7, and the test tube 6 is fixed through vacuum adsorption. As the rotating column 13 rotates again, the driving shaft 31 and the rotating plate 32 are driven to rotate half a circle through the synchronous wheel 69 and the synchronous belt 70. In this case, due to the gravity of the vertical rod 36 and the test tube 6, the test tube 6 always maintains a vertical state. When the rotating plate 32 rotates half a circle, the test tube 6 is accurately placed in the corresponding insertion hole of the placing rack 43. When the rotating column 13 resets and rotates, the rotating plate 32 is also reset accordingly.

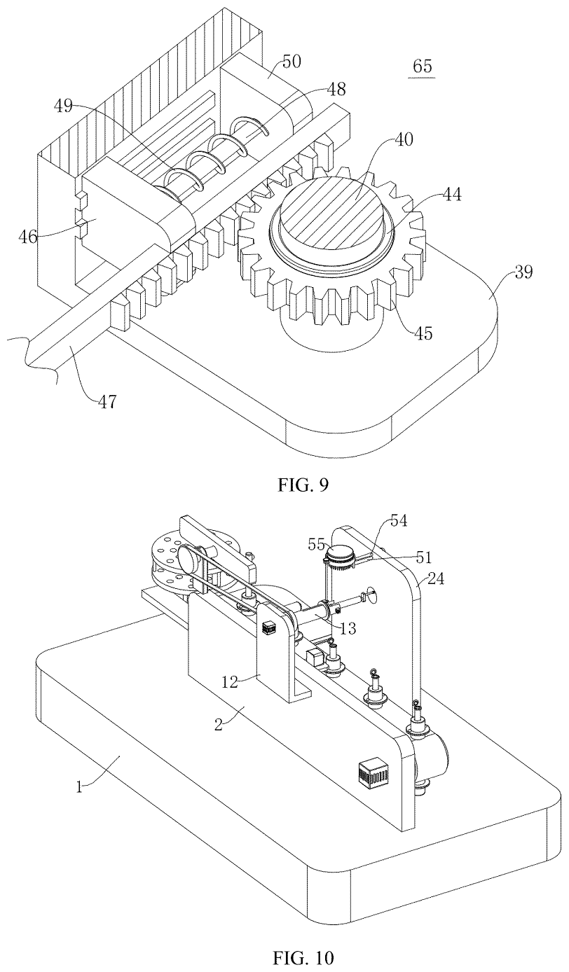

Referring to FIGS. 2, 4, 8 and 9, the rotating structure 65 drives the rotating rod 40 to rotate in the U-shaped bracket 39 by a motor, thereby driving the placing rack 43 to rotate, so that the test tubes 6 are placed in the insertion holes one by one, so as to ensure that the test tubes 6 may be placed on the placing rack 43 smoothly. The rotating structure 65 includes a first one-way bearing 44 sleeved on the outer wall of the rotating rod 40, and the bearing is positioned in the U-shaped bracket 39. The first gear 45 is fixed to an outer ring of the first one-way bearing 44, and the inner ring is fixed to an outer wall of the rotating rod 40. This design enables the first gear 45 to drive the rotating rod 40 to rotate in one direction. A supporting plate 46 is slidably connected to an inner wall of one side of the U-shaped bracket 39, and a rack 47 engaged with the first gear 45 is fixed on the supporting plate 46. To ensure the reset of the rack 47, a positioning block 50 is further provided in the U-shaped bracket 39, an insertion rod 48 slidably penetrates through the positioning block 50, one end of the insertion rod 48 is fixedly connected to the supporting plate 46, and a second spring 49 is further arranged between the supporting plate and the positioning block. When the conveying belt 4 drives the placing sleeve 5 to move to one side of the rotating roller 3, the hemispherical protrusion 11 arranged on the fixing ring 10 on the outer wall of the placing sleeve 5 pushes the rack 47 to move towards the right side, the rack 47 cooperates with the first gear 45 to drive the first one-way bearing 44 to rotate, and the first one-way bearing 44 and the rotating rod 40 are in a locking state, so that the rotating rod 40 and the placing rack 43 may be driven to rotate, and the angle of the placing rack 43 is adjusted. After the hemisphere protrusion 11 is separated from the rack 47, the rack 47 resets under the action of the second spring 49, and drives the first gear 45 to rotate in the opposite direction. However, in this case, the first one-way bearing 44 and the rotating rod 40 are in a movable state, and the placing rack 43 does not rotate any more.

Referring to FIGS. 2 and 4, a cap 7 is rotatably connected to an outer wall of the test tube 6, and a circular clamping groove 8 is formed in an inner wall of the test tube 6 close to an opening. A rubber ring 9 is fixed at one side of the cap 7. When the cap 7 is rotated to fit tightly with the opening of the test tube 6, the rubber ring 9 is embedded in the annular groove 8, thereby increasing the stability of the seal.

Specifically, a rotating wheel 30 is rotatably connected to one side of the first mounting plate 2, and after the test tube 6 is placed at a specific position, the rotating wheel 30 contacts the cap 7 and pushes the cap to rotate until the cap 7 completely seals the test tube 6, thereby completing the sealing process of the sampling test tube 6.

Referring to FIGS. 2 and 8, to achieve stable connection and angle limitation between the rotating rod 40 and the placing rack 43, the specific implementations are as follows:

First, a bottom plate 41 is fixedly secured to a top end of the rotating rod 40, and a plurality of pins 42 are uniformly distributed on the top of the bottom plate 41. The design of these pins 42 needs to ensure accurate matching with the pin holes 72 at the bottom of the placing rack 43. When the placing rack 43 is assembled, the pin holes 72 at the bottom of the placing rack need to be aligned with the pins 42 on the bottom plate 41 and inserted, so as to achieve the stable connection and positioning of the placing rack 43 and the bottom plate 41.

This design not only allows the bottom plate 41 to drive the placing rack 43 to rotate together, but also effectively limits the placement angle of the placing rack 43 through the cooperation between the pins 42 and the pin holes 72. This feature is particularly important in subsequent operations because this design ensures that the insertion holes on the placing rack 43 may accurately cooperate with the vertical rod 36, thereby smoothly receiving the test tubes 6, and significantly reducing the testing error rate caused by position deviation.

Through the specific implementations, the automated medical sampling and transportation line of the present invention may effectively reduce the testing error rate and improve the efficiency and accuracy of sampling and transportation.

### Embodiment 2

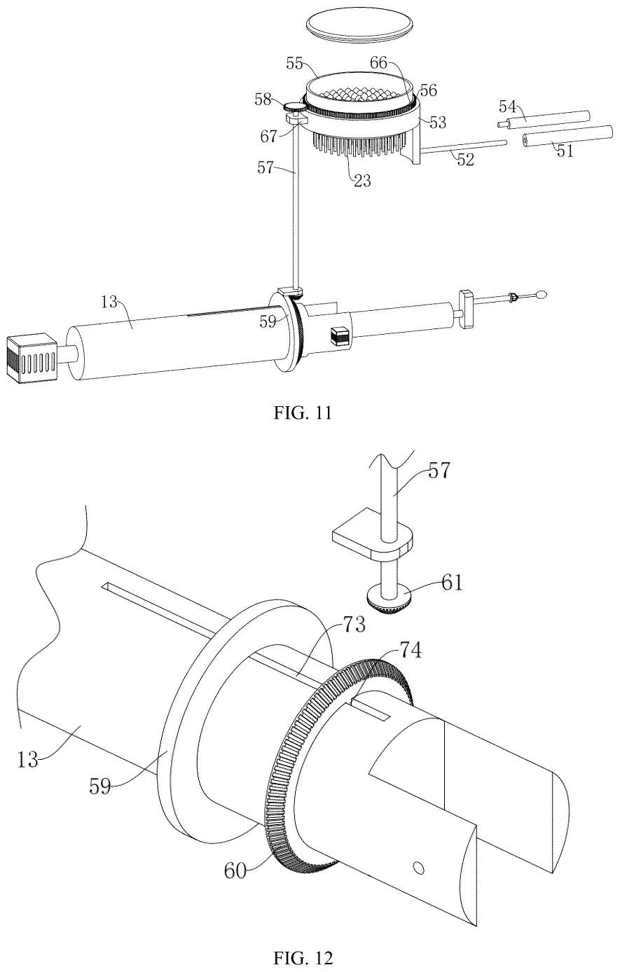

Referring to FIGS. 10-12, an improvement is made on the basis of Embodiment 1: a fixed cylinder 51 is fixedly mounted on one side of the support plate 24 close to the first mounting plate 2. A circular rod 52 is slidably connected inside the fixed cylinder 51, and one end of the circular rod 52 is fixedly connected to a circular ring 53. A third electric push rod 54 is fixedly mounted at one side of the support plate 24, and an output shaft of the third electric push rod is directly connected to the circular ring 53 and configured to push the circular ring 53 and the circular rod 52 to slide in the fixed cylinder 51.

The circular ring 53 is rotatably connected to a circular placement box 55, a plurality of pharyngeal swabs 23 are placed in the circular placement box, and a bottom end of a wooden stick of each pharyngeal swab 23 extends below the circular placement box 55 to facilitate the grabbing. A second one-way bearing 66 is sleeved on an outer wall of the circular placement box 55, an inner ring of the second one-way bearing is fixedly connected to an outer wall of the circular placement box 55, and a straight-tooth ring 56 is fixedly sleeved on an outer ring of the second one-way bearing.

One side of the circular ring 53 is rotatably connected to a driving rod 57 through a base 67, and a second gear 58 is fixed at a top end of the driving rod 57 and is meshed with the straight-tooth ring 56. Meanwhile, a bevel gear 61 is fixed to the bottom end of the driving rod 57. A collar 59 is sleeved on an outer wall of the rotating column 13, the collar 59 is likewise rotatably connected to the driving rod 57 through the base 67, and one side of the collar is rotatably connected to a bevel gear ring 60 meshed with the bevel gear 61. The bevel gear ring 60 is slidably sleeved on the outer wall of the rotating column 13, and cooperates with the sliding groove 73 of the outer wall of the rotating column 13 through a plurality of sliding blocks 74 to ensure that the bevel gear ring slides along the axial direction while rotating.

Specifically, when the motor drives the rotating shaft 14 and the support rod 15 to rotate by 90°, the support rod 15 drives the mechanical claw 22 to rotate to the lower part of the circular placement box 55. In this case, the first electric push rod 16 cooperates with the mechanical claw 22 to complete the grabbing operation of the pharyngeal swab 23 inside the circular placement box 55.

During the rotation of the rotating column 13, the precise coordination of the bevel gear ring 60, the bevel gear 61, the straight-tooth ring 56 and the second gear 58 may drive the circular placement box 55 to rotate in one direction, thereby adjusting the position of the pharyngeal swab 23 inside the circular placement box, and facilitating the subsequent grabbing of the mechanical claw 22. It should be noted that when the rotating column 13 rotates in the opposite direction, due to the presence of the second one-way bearing 66, the straight-tooth ring 56 cannot drive the circular placement box 55 to rotate, thereby ensuring the stability and reliability of the system.

In addition, the output shaft of the third electric push rod 54 may push the circular ring 53 and the circular placement box 55 to move integrally, thereby providing the mechanical claw 22 with gripping points for the pharyngeal swab 23 at different positions, and further improving the flexibility and efficiency of the system.

To ensure that the rotating column 13 can stably and effectively drive the circular placement box 55 to rotate when rotating, the specific implementations are as follows:

A plurality of sliding grooves 73 are provided on the outer wall of the rotating column 13, and a plurality of sliding blocks 74 matched with the sliding grooves 73 are fixed on the inner wall of the bevel gear ring 60.

Specifically, when the rotating column 13 rotates, the bevel gear ring 60 may be driven to rotate together with the cooperation between the sliding groove 73 and the sliding block 74. Meanwhile, since the driving rod 57 is connected to the bevel gear ring 60 through the collar 59, the bevel gear ring 60 slides along the axial direction of the rotating column 13 when rotating. This design ensures that no matter what position the rotating column 13 is in, the bevel gear ring 60 may maintain a stable meshing relationship with the bevel gear 61, thereby continuously and effectively driving the circular placement box 55 to rotate.

A method for using the automated medical sampling and transportation line for reducing testing error rate includes the following steps:
S1. When a specimen needs to be collected, a test tube 6 is inserted into a placing sleeve 5, a cap 7 is opened, the opening position of the cap 7 faces to the left side, an identity card reader 28 reads identity information of a patient, and a camera 27 takes a picture of the appearance of the patient. Then the patient places the chin on a chin rest 25 and aligns the mouth with a sampling hole 26 to facilitate later specimen collection. The camera 27 and the identity card reader 28 transmit the information to the Internet by a control terminal 68, and the Internet uses the inkjet printer 29 to spray patient information in the form of a QR code onto an outer wall of the test tube 6. This allows the collected specimen to be placed inside the test tube 6, thereby preventing confusion between the specimen and patient information.
S2. During detection, an output shaft of a first electric push rod 16 pushes a second mounting plate 17 and a wiping arm 20 through the sampling hole 26 and inserts the wiping arm into the oral cavity of the patient, and then a motor drives the rotating column 13 and the wiping arm 20 to rotate. Since the wiping arm 20 moves upward under the action of the first spring 21, the second mounting plate 17 drives the wiping arm 20 and the pharyngeal swab 23 to rotate eccentrically, and after rotating one circle, the wiping arm and the pharyngeal swab rotate in an opposite direction to reset, and the pharyngeal swab 23 wipes the oral cavity of the patient to complete the specimen collection. Afterwards, the first electric push rod 16 drives the second mounting plate 17 to retract and reset, the motor drives a support rod 15 to rotate 90° through a rotating shaft 14 to arrange vertically downward, the mechanical claw 22 releases the clamping of the pharyngeal swab 23, and the pharyngeal swab 23 falls into the test tube 6.
S3. The test tube 6 is conveyed to the right side by the cooperation of a rotating roller 3 and a conveying belt 4, and a rotating wheel 30 just abuts against the cap 7 to seal the test tube 6 by the cap 7, so that the stability of the sealing of the cap 7 is ensured by the cooperation of a rubber ring 9 and an annular clamping groove 8. The conveying belt 4 conveys the test tube 6 to a bottom of a vertical rod 36, and a vacuum cup 37 abuts against the top of the cap 7, and the test tube 6 is adsorbed by the vacuum cup 37. When the rotating column 13 rotates again to complete the next specimen collection, the rotating column 13 rotates one circle to drive a driving shaft 31 and a rotating plate 32 to rotate half a circle through a synchronous wheel 69 and a synchronous belt 70, and the rotating plate 32 drives the test tube 6 to move toward a placing rack 43 through a sliding block 34. Due to the action of the vertical rod 36 and the test tube 6, when the rotating plate 32 rotates, the vertical rod 36 and the test tube 6 always keep in a vertical state. The test tube 6 may be placed in the placing rack 43 when the rotating plate 32 rotates half a circle, and the rotating plate 32 resets when the rotating column resets 13.
S4. The placing sleeve 5 is driven to move along with the conveying belt 4, when the placing sleeve 5 moves to one side of the rotating roller 3, the hemispherical protrusion 11 on the outer wall of the placing sleeve 5 pushes a rack 47 to move towards the right side, and the rack 47 cooperates with the first gear 45 to drive the first one-way bearing 44 to rotate. The first one-way bearing 44 and the rotating rod 40 are in a locked state, the rotating rod 40 and the placing rack 43 are driven to rotate, and the angle of the placing rack 43 is adjusted, so that the test tube 6 may be conveniently placed on the placing rack 43 later. After the hemispherical protrusion 11 is separated from the rack 47, the rack 47 resets under the action of the second spring 49, the rack 47 drives the first gear 45 to rotate in an opposite direction, and the first one-way bearing 44 and the rotating rod 40 are in a movable state.
S5. When the mechanical claw 22 grabs a new pharyngeal swab 23 for specimen collection, the motor drives the rotating shaft 14 and the support rod 15 to rotate 90°, the support rod 15 drives the mechanical claw 22 to rotate upward, the mechanical claw 22 is positioned below the circular placement box 55, and the first electric push rod 16 cooperates with the mechanical claw 22 to grab the pharyngeal swab 23 in the circular placement box 55. In addition, when the rotating column 13 rotates, the circular placement box 55 is driven to rotate through the cooperation of a bevel gear ring 60, a bevel gear 61, a straight-tooth ring 56, and a second gear 58, and the position of the circular placement box 55 is adjusted to facilitate the mechanical claw 22 to grab the pharyngeal swab 23 later. When the rotating column 13 rotates in the opposite direction, the second one-way bearing 66 between the straight-tooth ring 56 and the circular placement box 55 cannot make the straight-tooth ring 56 drive the circular placement box 55 to rotate. In addition, the output shaft of the third electric push rod 54 can push the circular placement box 55 to move, so that the mechanical claw 22 may change the position to grab the pharyngeal swab 23.

However, it is well known to those skilled in the art that the working principles and wiring methods of the third electric push rod 54, the second electric push rod 35, the first electric push rod 16, the inkjet printer 29, the identity card reader 28 and the camera 27 are common, and are all conventional means or common knowledge, and the working principles and wiring methods are not be elaborated herein. Those skilled in the art may make any optional selections according to a requirement or convenience.

The above description is merely preferred implementation of the present invention, but is not intended to limit the protection scope of the present invention. Any equivalent replacements or changes made by any of those familiar with the technical field within the technical scope disclosed by the present invention according to the technical solutions and the inventive concepts of the present invention shall fall within the protection scope of the present invention.

What is claimed is:

1. An automated medical sampling and transportation line for reducing testing error rate, comprising a base, wherein a first mounting plate is fixed to a top of the base, two rotating rollers are rotatably connected to one side of the first mounting plate, the two rotating rollers are in transmission connection by a conveying belt, a plurality of placing sleeves are fixed to an outer wall of the conveying belt, and test tubes are placed in the placing sleeves;
a rotating column above the first mounting plate, wherein a pharyngeal swab is mounted at one end of the rotating column and configured to collect an oral specimen from a patient, a support plate is fixed to a top of the base, a sampling hole is formed in the support plate, and the pharyngeal swab penetrates through the sampling hole and is configured to collect the specimen;
a placing rack arranged at one side of the first mounting plate, wherein a connecting plate is fixed at one end of the first mounting plate, a U-shaped bracket is fixed at one side of the connecting plate, a rotating rod rotatably penetrates through the U-shaped bracket, the placing rack is placed at a top end of the rotating rod, and a plurality of inserting holes configured to place the test tubes are provided in the placing rack;
a vacuum cup arranged at one side of the first mounting plate and configured to place a test tube with the specimen in the placing rack;
an identification structure arranged at one side of the support plate and configured to associate information of a patient with a corresponding test tube;
a collection structure arranged at a top of the first mounting plate and configured to drive the pharyngeal swab to collect a specimen;
a transportation structure arranged at a top of the first mounting plate and configured to place a test tube with the collected specimen on the placing rack;
a rotating structure arranged in the U-shaped bracket and configured to drive the placing rack to rotate, so that the test tube is placed in the placing rack; wherein a fixed cylinder is fixed at one side of the support plate close to the first mounting plate, a circular rod is slidably connected in the fixed cylinder, a circular ring is fixed at one end of the circular rod, a third electric push rod is fixed at one side of the support plate, an output shaft of the third electric push rod is fixedly connected to the circular ring, the third electric push rod is configured to push the circular ring to move, a circular placement box is rotatably connected in the circular ring, a plurality of pharyngeal swabs are placed in the circular placement box, a bottom end of a wooden stick of each pharyngeal swab extends below the circular placement box, a second one-way bearing is sleeved on an outer wall of the circular placement box, an inner ring of the second one-way bearing is fixedly connected to an outer wall of the circular placement box, a straight-tooth ring is fixedly sleeved on an outer ring of the second one-way bearing, a driving rod is rotatably connected to one side of the circular ring through the base, a second gear is fixed to a top end of the driving rod, the second gear is meshed with the straight-tooth ring, the straight-tooth ring cooperates with the second one-way bearing to drive the circular placement box to rotate in one direction, a bevel gear is fixed to a bottom end of the driving rod, a collar is sleeved on an outer wall of the rotating column, the collar is rotatably connected to the driving rod through the base, one side of the collar is rotatably connected to a bevel gear ring meshed with the bevel gear, and the bevel gear ring is slidably sleeved on the outer wall of the rotating column.

2. The automated medical sampling and transportation line for reducing testing error rate according to claim 1, wherein the identification structure comprises a camera and a chin rest fixed at one side of the support plate, the camera is configured to collect facial data of a patient, the chin rest is configured to support the chin of the patient, an identity card reader is fixed at the top of the base and configured to read identity card information of the patient, an inkjet printer is fixed at the top of the first mounting plate, the inkjet printer is configured to spray a QR code on the outer wall of the test tube, a control terminal is provided in the base, and the camera, the identity card reader and the inkjet printer are all electrically connected to the control terminal.

3. The automated medical sampling and transportation line for reducing testing error rate according to claim 1, wherein the collection structure comprises an L-shaped bracket fixed at one side of the first mounting plate far away from the conveying belt, one side of the L-shaped bracket close to the conveying belt is rotatably connected to one end of the rotating column, a rotating shaft is rotatably connected in the rotating column, a support rod is fixedly sleeved on an outer wall of the rotating shaft, a first electric push rod is fixedly embedded at one end of the support rod, a second mounting plate is fixed at an output end of the first electric push rod, a rectangular groove is formed at one side of the second mounting plate far away from the support rod, a wiping arm is slidably connected in the rectangular groove, a guide rod slidably penetrating through the wiping arm is fixed in the rectangular groove, a first spring fixedly connected to an inner wall of a bottom of the rectangular groove is sleeved on an outer wall of the guide rod, a top of the first spring is fixedly connected to a bottom of the wiping arm, the first spring cooperates with the guide rod to move the wiping arm upward and away from a center, and a mechanical claw is fixed to an outer wall of the wiping arm and configured to grab the pharyngeal swab.

4. The automated medical sampling and transportation line for reducing testing error rate according to claim 3, wherein the transportation structure rotates a driving shaft at the top of the first mounting plate through the base, the driving shaft is in transmission connection with the rotating column through a synchronous wheel and a synchronous belt, the rotating column rotates one circle to drive the driving shaft to rotate half a circle, a rotating plate is fixed at one end of the driving shaft, a clearance groove is provided at one side of the rotating plate, a sliding block is slidably connected in the clearance groove, a second electric push rod is fixed on an inner wall of one side of the clearance groove, an output shaft of the second electric push rod is fixedly connected to the sliding block for adjusting positions of the sliding block and the vacuum cup, so that the vacuum cup places the test tube in a corresponding inserting hole on the placing rack, a vertical rod is rotatably connected to one side of the sliding block by a fixed column, a bottom end of the vertical rod is fixedly connected to the vacuum cup, and the gravity of the vertical rod and the vacuum cup keeps the vertical rod in a vertical state.

5. The automated medical sampling and transportation line for reducing testing error rate according to claim 4, wherein the rotating structure comprises a first one-way bearing sleeved on an outer wall of the rotating rod, the first one-way bearing is positioned in the U-shaped bracket, a first gear is fixed on an outer ring of the first one-way bearing, an inner ring of the first one-way bearing is fixed on the outer wall of the rotating rod, the first gear cooperates with the first one-way bearing to drive the rotating rod to rotate in one direction, a supporting plate is slidably connected to an inner wall of one side of the U-shaped bracket, a rack meshed with the first gear is fixed at one side of the supporting plate, a positioning block is fixed on the inner wall of one side of the U-shaped bracket, an insertion rod slidably penetrates into the positioning block, one end of the insertion rod is fixedly connected to the supporting plate, a second spring is fixed between the supporting plate and the positioning block, the second spring is sleeved on an outer wall of the insertion rod, the second spring is configured to drive the rack and the first gear to reset, a fixing ring is fixedly sleeved on an outer wall of the placing sleeve, hemispherical protrusions are fixed on two sides of a top of the fixing ring, and the hemispherical protrusions cooperate with the rack to drive the rack to move to one side.

6. The automated medical sampling and transportation line for reducing testing error rate according to claim 1, wherein a cap is rotatably connected to an outer wall of the test tube, a circular clamping groove is formed in an inner wall of the test tube close to an opening, a rubber ring is fixed to one side of the cap, the rubber ring cooperates with the circular clamping groove for increasing the stability of sealing between the cap and the test tube, and a rotating wheel is rotatably connected to one side of the first mounting plate and configured to push the cap to seal the test tube.

7. The automated medical sampling and transportation line for reducing testing error rate according to claim 1, wherein a bottom plate is fixed on the top end of the rotating rod, a plurality of pins are provided on a top of the bottom plate, and a plurality of pin holes matched with the pins are provided on a bottom of the placing rack for positioning the placing rack and the bottom plate.

8. The automated medical sampling and transportation line for reducing testing error rate according to claim 7, wherein a plurality of sliding grooves are provided on the outer wall of the rotating column, a plurality of sliding blocks are fixed to an inner wall of the bevel gear ring, and the sliding blocks are slidably arranged in the sliding grooves.

9. A method for using the automated medical sampling and transportation line for reducing testing error rate according to claim 8, comprising the following steps:
S1. the test tube is inserted into the placing sleeve, and the cap is opened facing to a left side; identity information and an appearance of a patient are recorded through the identity card reader and the camera; the chin of the patient is placed on the chin rest, and the mouth of the patient is aligned with the sampling hole for sampling; the information is automatically transmitted to the Internet, and the inkjet printer generates a QR code on the outer wall of the test tube to ensure that specimen information is accurate;
S2. the first electric push rod pushes the wiping arm to enter the oral cavity of the patient, and a motor drives the wiping arm to eccentrically rotate so as to complete specimen collection by the pharyngeal swab; after collection, the first electric push rod resets, the motor adjusts a direction of the support rod, and the mechanical claw releases the pharyngeal swab into the test tube;
S3. the conveying belt drives the test tube to a capping position, and the rotating wheel automatically caps; the vacuum cup absorbs the test tube, rotates to a position above the placing rack along with the rotating plate and accurately places the test tube;
S4. when the placing sleeve moves, the hemispherical protrusion triggers the rack to drive the placing rack to rotate to a proper angle; after the rack resets, the first one-way bearing is unlocked, and the placing rack keeps a current angle;
S5. the mechanical claw is driven by the motor to cooperate with the first electric push rod to grab a new pharyngeal swab from the circular placement box; the rotating column adjusts a position of the circular placement box through gear transmission to facilitate the mechanical claw to grab; and the third electric push rod pushes the circular placement box to increase grabbing flexibility.
